(19) United States
(12) Patent Application Publication
(10) Pub. No.: US 2008/0100141 A1
(43) Pub. Date: May 1, 2008

(54) Redundant Power Supply For Power-Over-Ethernet

(75) Inventors: Seok Chin Lee, Singapore (SG); Wei Thiam Neo, Singapore (SG)

Correspondence Address: SUGHRUE MION, PLLC, 2100 PENNSYLVANIA AVENUE, N.W., SUITE 800, WASHINGTON, DC, 20037, US

(73) Assignee: St. Electronics (Info-Comm Stystems) PTE.LTD., Singapore (SG)

(21) Appl. No.: 11/667,262

(22) PCT Filed: Nov. 9, 2004
(86) PCT No.: PCT/SG04/00367

§ 371 Date: Oct. 30, 2007

(51) Int. Cl. H02J 1/10

(52) U.S. Cl. 307/43

(57) ABSTRACT

Techniques for providing a redundant power supply for an Ethernet device are provided. A first flyback switching regulator draws power from a first Ethernet port. A second flyback switching regulator draws power from a second Ethernet port. Drawn power is regulated by each regulator and sent to a power combiner. The power combiner combines power from each regulator and supplies the combined power to the Ethernet device.

### FIELD OF THE INVENTION

The present invention is related to a power supply for a networked device, and more particularly to a redundant power supply for a networked device which draws power over a network.

### BACKGROUND OF THE INVENTION

Power-Over-Ethernet is a new technology that enables DC power to be supplied to Ethernet devices over 10BASE-T, 100BASE-TX, OR 1000BASE-T cabling. This technology enables the devices to receive their operating power over the same Ethernet local area network (LAN) that they use for data communication. It thus eliminates the need to connect each terminal to an AC power source, and to provide each terminal with its own AC/DC power converter. The LAN/MAN Standards Committee of the IEEE Computer Society has developed draft standards for Power-Over-Ethernet which are described in IEEE Std 802.3af™, which is incorporated herein by reference.

A typical Power-Over-Ethernet system comprises an Ethernet switch and a power hub, which supplies DC power, along with a number of devices, which communicate via the switch and draw power from the hub. The system is typically connected in a star topology, with each device linked by a dedicated cable to the switch and hub. The power sourcing equipment in the hub is commonly referred to as Power Sourcing Equipment (PSE), while each device that receives the power is commonly referred to as a Powered Device (PD). The PSE may be integrated with the switch, in what is known as an “end-span” configuration, or it may alternatively be located between the switch and the devices, in a “mid-span” configuration.

A LAN in which a PSE is operating may include not only PDs, but also legacy devices that are not configured to receive power over the LAN. In order to avoid damaging legacy devices by applying high DC voltage to their LAN connections, the PSE must be able to determine, for each of its power output ports, whether or not the output is connected to a PD. For this purpose, the IEEE 802.3™ draft standards require that each PD include a “signature element” that is a special circuit across the power input connections of the PD with predefined impedance characteristics. When the PSE is powered up, or when a new device is added to the LAN, the PSE performs a line interrogation routine in order to detect the signature element. During the line interrogation phase, the remaining circuits of the PD (other than the signature element) are isolated from the line by a switch. Upon successful completion of the interrogation, the isolating switch is closed, and the PSE begins to supply power to the PD. The interrogation routine uses low-voltage signals, in order to avoid damaging legacy device equipment.

Once the PSE has begun to supply power to a PD, it must also be able to detect when the PD is disconnected from the LAN, in order to avoid leaving high DC voltage on the open line. For this purpose, the IEEE 802.3af™ draft standards specify that the PSE should continuously sense the DC current that it supplies to the PD. If the current drawn from a given output port of the PSE drops below 10 mA for a certain period of time, the PSE shuts off its DC output voltage to that port. This disconnect detection mechanism solves the problem of leaving DC voltage on an open line, and it prevents device damage in the event that a legacy terminal is connected in place of the disconnected PD. The mechanism requires, however, that the PD consume a certain amount of current at all times, even when it is idle. Otherwise, the PSE will cut off power to the PD.

Many types of network equipment can be designed to utilize Power-Over-Ethernet connections, including Voice-Over-IP phones (VoIP phones), in accordance with the IEEE 802.3af™ draft standards. The power source for many VoIP phones is conventional AC service. This presents a problem, in that if AC service is lost (i.e., in a power failure), the VoIP phone drawing power from that service is not usable. A VoIP phone utilizing a Power-Over-Ethernet connection is still usable in a power failure as long as the PSE powering the VoIP phone has power. PSEs with backup power are known. Thus, the PSE can supply power to network equipment even during a power failure.

For many network devices, it is critical that they be available for use. In other words, such devices have a mission critical application. It is desirable for mission critical devices to have redundant power sources such that if one power source fails, backup power is supplied by the other, redundant, power source.

Because of the current detection requirements of the IEEE 802.3af™ draft standards, to date, redundant Power-Over-Ethernet connections have not been utilized. That is, a Power-Over-Ethernet connection that serves as a backup power source to another Power-Over-Ethernet connection is not currently available, because, as no current would normally be drawn from that backup Power-Over-Ethernet connection, the PSE supplying the backup power would shut off the DC output voltage to the port to which the backup power is connected. Thus, backup power would not be available.

Accordingly, a need exists for a technique of supplying redundant power via a Power-Over-Ethernet connection in accordance with the IEEE 802.3af™ draft standards.

### OBJECTS OF THE INVENTION

It is an object of the present invention to provide a technique for supplying both primary and redundant, backup, power via Power-Over-Ethernet connections.

The above-stated objects, as well as other objects, features, and advantages, of the present invention will become readily apparent from the following detailed description which is to be read in conjunction with the appended drawings.

### SUMMARY OF THE INVENTION

In accordance with the present invention, a system and a method for providing redundant power to an Ethernet device are provided. The Ethernet device could be any type Ethernet device, including, but not limited to, a VoIP phone. According to the technique described herein, the Ethernet device is designed to receive power over the Ethernet. Preferably, though not necessarily, the power is received in accordance with the IEEE 802.3af™ draft standard.

A system to implement the method includes a first flyback switching regulator and a second flyback switching regulator. Each flyback switching regulator has an Ethernet port for drawing power, at least one circuit for regulating the drawn power, and an output port for outputting the regulated power. Also included is a power combiner that receives power from each of the flyback switching regulators. The received power is combined and supplied to the Ethernet device. It should be noted that, typically, less power will be received from one flyback switching regulator than from the other flyback switching regulator.

According to one aspect of the present invention, power drawn by the first flyback switching regulator is supplied by a first power source, and power drawn by the second flyback switching regulator is supplied by a second power source different than the first power source. Typically, a power source will be an Ethernet switch. However, one or both of the power sources could be, as desired, another type device capable of supplying power to an Ethernet port. Beneficially, each of the flyback switching regulators draws power such that the respective power source does not interrupt the supplied power.

In another aspect of the present invention, the system includes a duty cycle measurement circuit and a duty cycle control circuit. The measurement circuit measures the duty cycle of each flyback switching regulator. The control circuit controls the duty cycle of at least one of the first and second flyback switching regulators based upon the measured duty cycle of the other flyback switching regulator. It should be noted that two identical flyback switching regulators could have different duty cycles due to manufacturing differences. Controlling a duty cycle could include increasing a duty cycle, or decreasing a duty cycle.

In a further aspect, each flyback switching regulator has a shunt voltage regulator. Each shunt voltage regulator includes a reference pin and a high impedance resistance. To increase the duty cycle of a flyback switching regulator, the control circuit outputs a pulse width modulated signal that is transformed into a DC signal. The DC signal is fed to the shunt regulator associated with the flyback switching regulator being controlled. More particularly, the DC signal is fed through that shunt regulator's high impedance resistance and to the reference pin. This DC signal causes the duty cycle of that flyback switching regulator to increase.

According to another further aspect, the duty cycle measurement circuit and the duty cycle control circuit are each a part of a field programmable grid array. In yet another further aspect of the present invention, even if one or both of the measurement and/or control circuits is not operating, or not operating correctly, power is nonetheless supplied to the Ethernet device.

According to a beneficial aspect, the control circuit is configured to maximize control stability and dynamic response of the flyback switching regulator whose duty cycle is controlled.

In another further aspect, duty cycle is measured based upon switching pulses produced by a flyback switching regulator. The control circuit is further configured to determine a loss of power output by a switching regulator based upon a number of missed switching pulses. Such a loss of power could be the result of a failure of a flyback switching regulator, or could be the result of power not being supplied to a flyback switching regulator. According to a still further aspect, the control circuit is further configured to differentiate between a temporary loss of switching pulses and a power supply failure. This differentiation is based upon the number of missed switching pulses. That is, if the number of missed switching pulses is greater than a certain number of switching pulses, it is determined that a power supply failure has occurred (which, as above, could be due to a malfunction of a flyback switching regulator, or for some other reason), not a temporary loss of switching pulses.

According to yet another further aspect, the control circuit maintains the duty cycle of the flyback switching regulator having the lower duty cycle at a stand-off value that is less than that of the duty cycle of the other flyback switching regulator. This ensures that the flyback switching regulator having the higher duty cycle does not cut back the power it provides to the power combiner.

In still another further aspect, the duty cycle control circuit operates in one of three states. In the first state, the duty cycle control circuit does not control any duty cycle. In the second state, the duty cycle control circuit controls the duty cycle of the second flyback switching regulator based upon the measured duty cycle of the first flyback switching regulator, and in the third state, the duty cycle of the first flyback switching regulator is controlled based upon the measured duty cycle of the second flyback switching regulator.

According to an even further aspect of the present invention, the duty cycle control circuit transitions between operating in the various states based upon changes in measured duty cycles. In this aspect, a transition from the first state to the second state occurs when the duty cycle of the first flyback switching regulator is greater than the duty cycle of the second flyback switching regulator by more than a first threshold. This first threshold could be an absolute value, could be a percentage, or could be any other type threshold indicating differences between duty cycles.

A transition from the first state to the third state occurs when the duty cycle of the second flyback switching regulator greater than the duty cycle of the first flyback switching regulator by more than a second threshold. The second threshold, which could be the same as or different than the firs threshold, likewise could be an absolute value, a percentage, or any other type threshold indicating duty cycle differences. Also in this aspect, the duty cycle control circuit transitions to the first state from either of the second or third states when a duty cycle of one flyback switching regulator is less than the duty cycle of the other flyback switching regulator by less than a third threshold. Again, this third threshold could be an absolute value, a percentage, or any other threshold indicating a difference between duty cycles.

In an even further aspect, the first and second thresholds are the same threshold, and the third threshold is less than the first and second thresholds. Yet in a still further aspect, the first and second thresholds are each twenty percent, and the third threshold is ten percent. Thus, in this aspect, a transition from operating in the first state to operating in the second state occurs when the measured duty cycle of the first flyback switching regulator is twenty percent greater than the measured duty cycle of the second flyback switching regulator, a transition from operating in the first state to operating in the second state occurs when the measured duty cycle of the second flyback switching regulator is twenty percent greater than the measured duty cycle of the first flyback switching regulator, and a transition from either the second or third state to the first state occurs when one measured duty cycle is less then ten percent greater than the other measured duty cycle.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 depicts an Ethernet device receiving power via redundant Power-Over-Ethernet connections in accordance with certain aspects of the present invention.

FIG. 2 depicts the architecture of a power supply for a network device in accordance with the present invention.

FIG. 3 depicts a level shifting circuit in accordance with certain aspects of the present invention.

FIG. 4 depicts a PWM filter in accordance with certain aspects of the present invention.

FIG. 5 depicts a duty cycle control algorithm in accordance with certain aspects of the present invention.

### DETAILED DESCRIPTION OF A PREFERRED EMBODIMENT

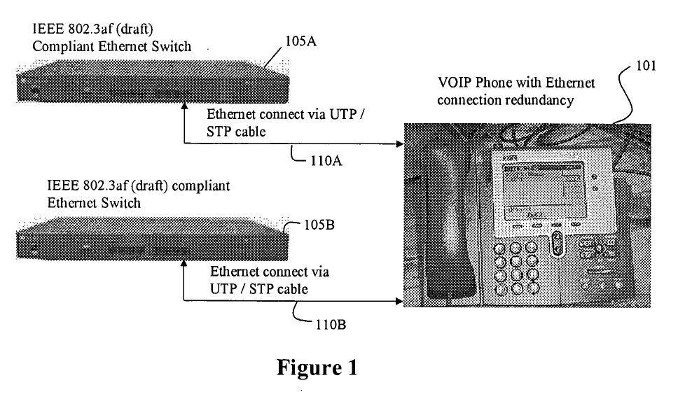

FIG. 1 is a simplified depiction of a VoIP phone 101 that receives power via redundant Power-Over-Ethernet connections in accordance with the present invention. Of course, the device associated with the redundant Power-Over-Ethernet connections could be any type network device. As will be understood from the discussion above, a IEEE 802.3af™ draft standards compliant Ethernet switch 105 supplies power via a cable 110. The Power-Over-Ethernet power source could be, as desired, separate from an Ethernet switch 105. As shown, a first IEEE 802.3af™ draft standards compliant Ethernet switch 105A and a second IEEE 802.3af™ draft standards compliant Ethernet switch 105B each supply power to the VoIP phone 101 in accordance with the present invention. Power from the first switch 105A is supplied via a first UTP/STP cable 110A, and power from the second switch 105B is supplied via a second UTP/STP cable 110B. If power is unavailable via one of the cables 110A or 110B, the other one of cables 110A or 110B supplies power to the VoIP phone 101.

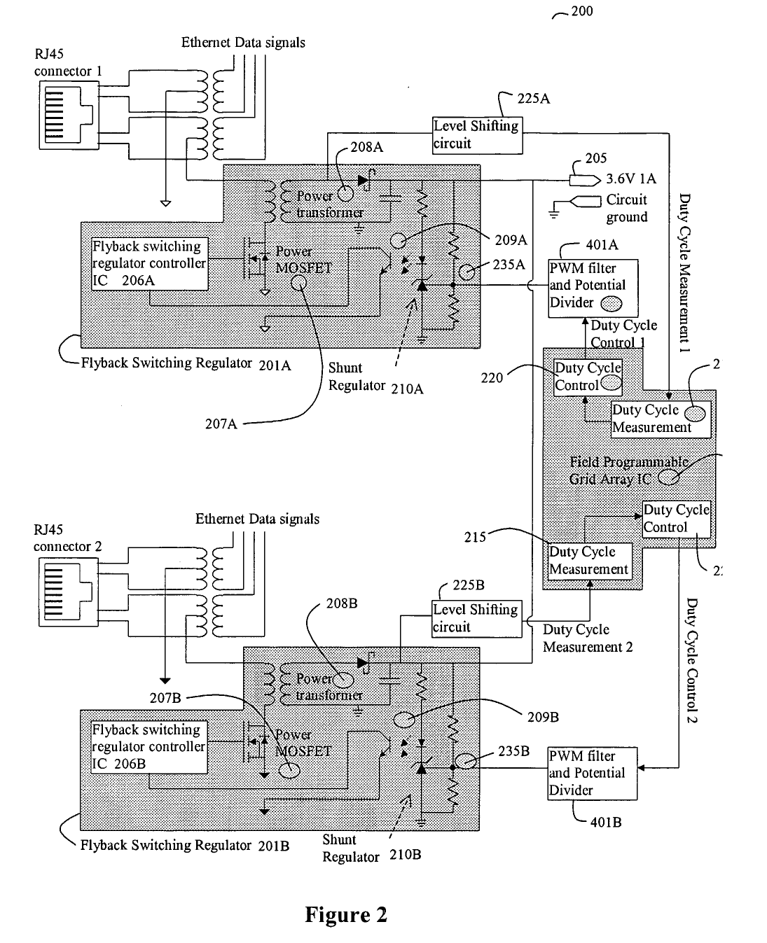

As shown in FIG. 2, a power supply 200 for the VoIP phone 101 includes two identical isolated Flyback Switching Regulators (fsr) 201 connected together 205 at their outputs. Regulator 201A draws power from cable 110A, and regulator 201B draws power from cable 110B. Regulators 201A and 201B are connected in parallel, with one serving as a hot standby (secondary). Each is capable of supplying, at its respective output, the required current, at 3.6V in the example discussed herein, to power the VoIP phone 101. As will be described in detail further below, a regulator 201 serving as the hot standby draws at least 10 mA of power so that the Ethernet switch 105 associated with that fsr 201 will continue to deliver power.

Each flyback switching regulator 201 includes a flyback switching regulator controller IC 206, with controller IC 206A associated with fsr 201A, and controller IC 206B associated with fsr 201B. Each flyback switching regulator 201 also includes a power MOSFET 207, with MOSFET 207A associated with fsr 201A, and MOSFET 207B associated with fsr 201B. A power transformer 208 is also included in each flyback switching regulator, with power transformer 208A associated with fsr 201A, and power transformer 208B associated with fsr 201B.

Additionally, an optocoupler 209 is also included in each fsr 201, with optocoupler 209A associated with fsr 201A, and optocoupler 209B associated with fsr 201B. Each flyback switching regulator 201 also includes a shunt voltage regulator 210, with shunt voltage regulator 210A associated with fsr 201A, and shunt voltage regulator 210B associated with fsr 201B.

Also included in the power supply 200 is a duty cycle measurement circuit 215 and a duty cycle control circuit 220, each to be discussed further below. Each regulator 201 is designed to function, in a reduced functionality mode, should either, or both, of circuits 215 and/or 220 fail. That is, power will still be supplied, at the required voltage, to the VoIP phone 101.

The duty cycle measurement circuit 215 measures switching pulses of each regulator 201 at the secondary side of each respective power transformer 208. Based upon the measured switching pulses the duty cycle measurement circuit 215 derives the duty cycle for each regulator 201.

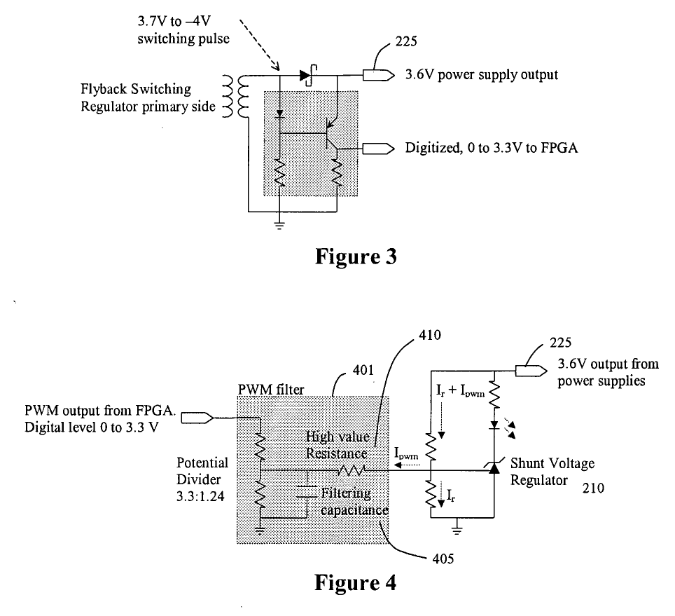

Because a flyback switching regulator 201 operates in discontinuous mode, the measured switching pulses may vary from −4V to 3.7V. This variance is not suitable for digital processing. Thus, each fsr 201 is associated with a respective level shifting circuit 225 which converts measured switching pulses to a digitally compatible voltage level. Flyback switching regulator 201A is associated with level shifting circuit 225A, and fsr 201B is associated with level shifting circuit 225B. FIG. 3 is a detailed representation of a level shifting circuit 225. As shown, level shifting circuit 225 includes a signal diode in series with a ballast resistor and a PNP transistor connected in a common emitter topology. When output from the flyback's transformer is at 3.7V, the diode is forward biased and pulls the base of the transistor to 3V. This effectively turns off the current through the transistor and the circuit outputs 0V at the Digitized Output. When output from the flyback's transformer is at −4V, the signal diode is reverse biased and the base of the transistor is pull towards 0V. This will cause the current through the transistor to flow and the circuits outputs about 3.3V at the Digitized Output. As desired, a P-channel MOSFET may be substituted for PNP transistor with the same results described when the PNP is used.

The converted switching pulses from a fsr 201 are sent to a field programmable grid array (FPGA) IC 230. The FPGA 230 measures the duty cycle of a fsr 201 by comparing the proportion of a transformer 208 charging time to the rest of the switching period. The result of the measurement is sent to the duty cycle control circuit 220, to be discussed further below.

Also, the measurement results are used to detect if any power is being supplied by a fsr 201. It should be noted that a lack of power could be due to a failure of a fsr 201 itself, or by a failure upstream of a fsr 201, such as a Ethernet switch 105 or a cable 110. Power failure, no matter the cause, is indicated by a threshold number of switching cycles in which no switching pulse is measured. This threshold number may set as desired. In one preferred implementation, the threshold is set at 50 or greater switching cycles of no measured switching pulse. Of course, as desired, the threshold may be set at a number greater than 50, or less than 50. Shorter periods of no measured switching pulses, i.e., less than or equal to 50 switching cycles of the example above, are ignored, because the regulator 201A or 201B that is secondary may not generate switching pulses for such short periods of time

The duty cycle control circuit 220 utilizes the measurement results generated by the FPGA 230 to select the regulator 201 having the lower duty cycle to increase that flyback switching regulator's contribution to the current supplied to the VoIP phone 101, even if the duty cycle measurement circuit 215 indicates a power failure associated with that fsr 201. The fsr 201 having the lower duty cycle is the secondary fsr 201. Each fsr 201A and 201B is associated with a potential divider resistor 235, shown in the Figures as potential divider resistor 235A and potential divider resistor 235B. The duty cycle control circuit 220 manipulates the current flow of the potential divider resistor 235 associated with the secondary fsr 201 to increase its current contribution so that a switch 105 will continue to supply power to that fsr 201.

More particularly, the duty cycle control circuit 220 outputs a pulse width modulated (PWM) waveform at 150 KHz with settings from 0 to 100% duty in steps of 6.25% and amplitude of 3.3V. Each fsr 201 is associated with a PWM filter 401, shown in the Figures as filters 401A and 401B. The PWM signal is sent to the PWM filter 401 (shown in detail in FIG. 4) to reduce the amplitude of the PWM waveform to 1.24V, which is the same level as the reference voltage of a shunt voltage regulator 210. It will be understood that the PWM signal will be sent to the PWM filter 401 associated with the secondary fsr 201.

A PWM filter 401 has a large capacitance 405 connected to ground so that the alternating current (AC) component of the PWM 401 is filtered to ground. Because of capacitance 405, the output of the PWM filter 401 is a direct current (DC) voltage. The DC output voltage can be set between 0V to 1.24V in steps of 0.078V. The output of a PWM filter 401 is connected to a reference pin of a shunt regulator 210 via a high impedance 410 of 300 Kohms.

When the output of a PWM filter 401 is set to 0V, this causes a small (<2%) increase in the output voltage of a shunt regulator 210. This increase is applied to the secondary fsr 201 (i.e., the flyback switching regulator 201 that contributes the least, which could be zero, current to the VoIP phone 101.) The reason why a secondary fsr 201 contributes less current to the VoIP phone 101 is because of ordinarily occurring manufacturing differences which result in differences in output voltage settings between flyback switching regulators 201. For example, one fsr 201 may have an output voltage setting of 3.6V, while another might have an output voltage setting of 3.58V. Thus, in this example, the 3.58V fsr 201 would be the secondary fsr 201.

Whenever a secondary fsr 201 detects that its output voltage exceeds its output settings, it reduces its output current to bring the output voltage down. Of course, because the output voltage of the other (dominate) fsr 201 is greater than the output voltage of the secondary fsr 201, the output voltage of the secondary fsr 201 will never reduce, even when the secondary fsr reduces its output current to zero. In other words, the 3.6V of the present example will always be measured at its output.

When the duty cycle control circuit 220 raises the secondary flyback switching regulator's output voltage setting closer to that of the dominate fsr, the measured increase in the secondary flyback switching regulator's duty cycle is indicative of the secondary flyback switching regulator's output voltage setting approaching that of the dominate fsr. As the secondary flyback switching regulator's output current increases, the dominate fsr will cut back its own current contribution to the VoIP phone 101 to maintain its output voltage setting. Thus, the total current delivered to the VoIP phone 101 is consistent.

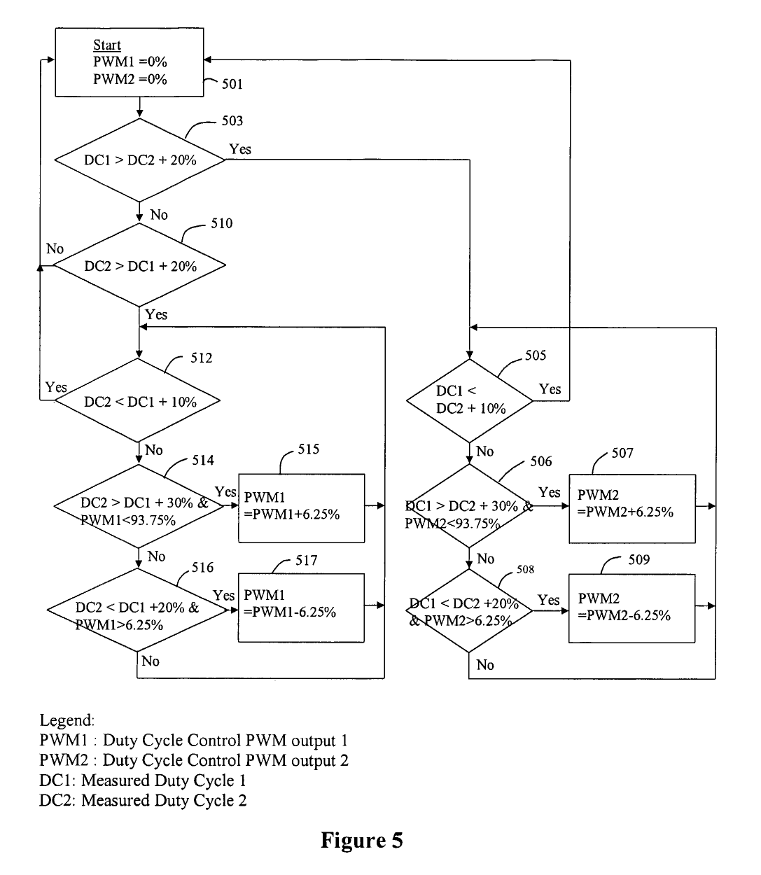

The duty cycle control circuit 220 utilizes a control algorithm, shown in FIG. 5, to regulate the flyback switching regulators 201A and 201B. The algorithm begins at step 501 in which both flyback switching regulators 201A and 201B are allowed to run without intervention from the duty cycle control circuit 220. At step 503, based upon the measured duty cycle of each fsr 201A and 201B, the algorithm determines if fsr 201A has a measured duty cycle twenty percent greater than that of fsr 201B. If not, operations continue with step 510 in which the algorithm determines if fsr 201B has a measured duty cycle twenty percent greater than that of fsr 201A. If the determination in step 510 is negative, operations return to step 501.

If at step 503 it is determined that fsr 201A has a measured duty cycle twenty percent greater than that of flyback back switching regulator 201B, operations continue with step 505. At step 505 the algorithm determines if the measured duty cycle of fsr 201A is less than the measured duty cycle of fsr 201B plus ten percent. If so, operations return to step 501. If not, operations continue with step 506 in which the algorithm determines if both the measured duty cycle of fsr 201A is thirty percent greater than that of fsr 201B and the PWM output to fsr 201B is less than 93.75 percent. If so, at step 507 the PWM output to fsr 201B is increased by 6.25 percent. From step 507, operation continue with step 505, described above.

If the determination at step 506 is negative, operations continue with step 508 in which the algorithm determines if both the measured duty of cycle of fsr 201A is twenty percent greater than that of fsr 201B and if the PWM output to fsr 201B is greater than 6.25 percent. If so, operations continue with step 509 in which the PWM output to fsr 201B is decreased by 6.25%. From step 509, or if the determination in step 508 is negative, operations continue with step 505, described above.

If the determination in step 510 is positive, operations continue with step 512 in which the algorithm determines if the measured duty cycle of fsr 201B is less than the measured duty cycle of fsr 201A plus ten percent. If so, operations return to step 501. If not, operations continue with step 514 in which the algorithm determines if both the measured duty cycle of fsr 201B is thirty percent greater than that of fsr 201B and the PWM output to fsr 201A is less than 93.75 percent. If so, at step 515 the PWM output to fsr 201A is increased by 6.25 percent. From step 515, operation continue with step 505, described above

If the determination at step 514 is negative, operations continue with step 516 in which the algorithm determines if both the measured duty of cycle of fsr 201B is twenty percent greater than that of fsr 201A and if the PWM output to fsr 201A is greater than 6.25 percent. If so, operations continue with step 517 in which the PWM output to fsr 201A is decreased by 6.25%. From step 517, or if the determination in step 516 is negative, operations continue with step 512, described above.

As shown in FIG. 5 and discussed in detail above, if one fsr 201 is determined to have a duty cycle much less than the other, the duty cycle control circuit 220 increases this secondary flyback switching regulator's PWM duty in steps of 6.25%. The algorithm constantly adjusts the PWM duty to keep the secondary flyback switching regulator's duty cycle 12 to 19 percent below that of the dominant flyback switching regulator's duty cycle. The algorithm also detects sharp drops in the dominant flyback switching regulator's duty cycle, in which case the algorithm will immediately return to the neutral state, i.e., step 501.

Thus, according to the Algorithm, the duty cycle control circuit operates in one of three states. In a first state, the difference between measured duty cycles of two flyback regulators is not significant, thus the duty cycle control circuit does not actively control either flyback switching regulator. In a second state, the duty cycle control circuit controls the duty cycle of a second flyback switching regulator based on the measured duty cycle of a first flyback switching regulator. In a third state, the duty cycle control circuit controls the duty cycle of the first flyback switching regulator based on measured duty cycle of the second flyback switching regulator. Transition from the first state to the second state is triggered when the measured duty cycle of first flyback switching regulator is significantly greater than second flyback switching regulator. Transition from the first state to the third state is triggered when the measured duty cycle of second flyback switching regulator is significantly greater than first flyback switching regulator. Transition from the second or third states to the first state is triggered when the difference in measure duty cycles for first flyback regulator and second flyback regulator is less than 10%.

The algorithm sets the duty cycle of the secondary fsr 201 such that the secondary flyback switching regulator's duty cycle is maintained at a stand-off value less than that of the dominant fsr's duty cycle. This is performed because if the secondary fsr duty cycle is made to increase higher than that of the dominate fsr's duty cycle, the output voltage may exceed the output voltage setting of the dominate fsr. In such a case, the dominate fsr would cut back its current contribution to zero percent, defeating the purpose of the duty cycle control circuit 220.

The degree of accuracy of the PWM output of the duty cycle control circuit 220 is designed to balance between stability and dynamic response. A smaller PWM discrete step achieves a stable duty cycle for the secondary fsr. However, due to the activity of the VoIP phone 101 (or other Power-Over-Ethernet equipment utilizing the present invention), there are fluctuations in the current demand. Therefore, the duty cycle control circuit 220 must be able to respond quickly to maintain the margin between the dominate fsr's duty cycle and the secondary fsr's duty cycle. A larger PWM step size achieves a fast response. To meet both requirements (stability and dynamic response), a step size of 6.25% is utilized. Of course, other step sizes, as desired, could be utilized.

The present invention is not to be limited in scope by the specific embodiments described herein. Indeed, various modifications of the present invention in addition to those described herein will be apparent to those of skill in the art from the foregoing description and accompanying drawings. Thus, such modifications are intended to fall within the scope of the appended claims.

What is claimed is:

1. A redundant power supply for an Ethernet device, comprising:
a first flyback switching regulator having a first Ethernet port for drawing power, at least one circuit for regulating the drawn power, and a first output port for outputting the regulated power;
a second flyback switching regulator having a second Ethernet port for drawing power, at least one circuit for regulating the drawn power, and a second output port for outputting the regulated power; and
a power combiner configured to combine the power output from the first flyback switching regulator and the power output from the second flyback switching regulator and to supply the combined power to the Ethernet device.

2. The redundant power supply of claim 1, wherein the Ethernet device is a Voice Over Internet Protocol telephone.

3. The redundant power supply of claim 1, wherein:
the power drawn by the first flyback switching regulator is supplied by a first power source;
the power drawn by the second flyback switching regulator is supplied by a second power source different than the first power source;
the first flyback switching regulator draws power through the first Ethernet port such that the first power source does not interrupt the flow of power to the first Ethernet port; and
the second flyback switching regulator draws power through the second Ethernet port such that the second power source does not interrupt the flow of power to the second Ethernet port.

4. The redundant power supply of claim 1, further comprising:
a duty cycle measurement circuit configured to measure the duty cycle of the first flyback switching regulator and the duty cycle of the second flyback switching regulator; and
a duty cycle control circuit configured to control the duty cycle of at least one of i) the first flyback switching regulator based upon the measured duty cycle of the second flyback switching regulator and ii) the second flyback switching regulator based upon the measured duty cycle of the first flyback switching regulator.

5. The redundant power supply of claim 4, wherein:
each flyback switching regulator includes a shunt voltage regulator having a reference pin and a high impedance resistance;
to increase the duty cycle of a flyback switching regulator, the duty cycle control circuit outputs a pulse width modulated signal to the reference pin, though the high impedance resistance, of the shunt voltage regulator associated with the flyback switching regulator having the controlled duty cycle; and
the output pulse width modulated signal is transformed into a DC signal prior to reaching the shunt voltage regulator.

6. T he redundant power supply of claim 4, wherein the duty cycle measurement circuit and the duty cycle control circuit are each a part of a field programmable grid array.

7. The redundant power supply of claim 4, wherein power is supplied to the Ethernet device irrespective of operation of at least one of the duty cycle measurement circuit and the duty cycle control circuit.

8. The redundant power supply of claim 4, wherein the duty cycle control circuit is configured to maximize control stability and dynamic response of a flyback switching regulator having a controlled duty cycle.

9. The redundant power supply of claim 4, wherein:
the duty cycle measurement circuit measures the duty cycle of the first flyback switching regulator based upon switching pulses produced by the first flyback switching regulator;
the duty cycle measurement circuit measures the duty cycle of the second flyback switching regulator based upon switching pulses produced by the second flyback switching regulator; and
the duty cycle control circuit is further configured to determine a loss of power supplied to the power combiner by the first flyback switching regulator based upon a number of missed switching pulses of the first flyback switching regulator, and to determine a loss of power supplied to the power combiner by the second flyback switching regulator based upon a number of missed switching pulses of the second flyback switching regulator.

10. The redundant power supply of claim 9, wherein the duty cycle control circuit is further configured to differentiate between temporary loss of switching pulses and power supply failure based upon the number of missed switching pulses.

11. The redundant power supply of claim 4, wherein the duty cycle control circuit is further configured to maintain the duty cycle of the flyback switching regulator having a lower measured duty cycle at a stand-off value less than that of the duty cycle of the flyback switching regulator having a higher measured duty cycle.

12. The redundant power supply of claim 4, wherein:
the duty cycle control circuit operates in one of three states:
when operating in a first state, the duty cycle control circuit does not control any duty cycle;
when operating in a second state, the duty cycle control circuit controls the duty cycle of the second flyback switching regulator based upon the measured duty cycle of the first flyback switching regulator; and
when operating in a third state, the duty cycle control circuit controls the duty cycle of the first flyback switching regulator based upon the measured duty cycle of the second flyback switching regulator.

13. The redundant power supply of claim 12, wherein:
the duty cycle control circuit transitions from operating in the first state to operating in the second state when the measured duty cycle of the first flyback switching regular is greater than the measured duty cycle of the second flyback switching regulator by more than a first threshold;
the duty cycle control circuit transitions from operating in the first state to operating in the third state when the measured duty cycle of the second flyback switching regulator is greater than the measured duty cycle of the first flyback switching regulator by more than a second threshold;
the duty cycle control circuit transitions from operating in the second state to operating in the first state when the measured duty cycle of the first flyback switching regulator is less than the measured duty cycle of the second flyback switching regulator by less than a third threshold; and
the duty cycle control circuit transitions from operating in the third state to operating in the first state when the measured duty cycle of the second flyback switching regulator is less than the measured duty cycle of the first flyback switching regulator by less than the third threshold.

14. The redundant power supply of claim 13, wherein:
the first threshold and the second threshold are the same threshold; and
the third threshold is less than the first and the second thresholds.

15. The redundant power supply of claim 13, wherein:
each of the first and the second thresholds are twenty percent; and
the third threshold is ten percent.

16. The redundant power supply of claim 1, wherein the Ethernet device is configured in accordance with the IEEE 802.3af standard.

17. A method for supplying redundant power to a Ethernet device, comprising:
receiving first Ethernet power and second Ethernet power;
regulating the received first Ethernet power and the second Ethernet power;
combining the regulated power; and
outputting the combined power to the Ethernet device.

18. The method of claim 17, wherein the Ethernet device is a Voice Over Internet Protocol telephone.

19. The method of claim 17, wherein:
the first Ethernet power is regulated such that a source of the first Ethernet power does not interrupt the first Ethernet power; and
the second Ethernet power is regulated such that a source of the second Ethernet power does not interrupt the second Ethernet power.

20. The method of claim 17, further comprising:
measuring a first duty cycle associated with regulating the first Ethernet power; and
measuring a second duty cycle associated with regulating the second Ethernet power; and
controlling at least one of i) the first duty cycle based upon the measured second duty cycle and ii) the second duty cycle based upon the measured first duty cycle.

21. The method of claim 20, wherein controlling a duty cycle includes one of i) increasing the controlled duty cycle, and ii) decreasing the controlled duty cycle.

22. The method of claim 20, wherein the first duty cycle is measured based upon switching pulses associated with regulating the first Ethernet power, and the second duty cycle is measured based upon switching pulses associated with regulating the second Ethernet power, and further comprising:
determining a loss of at least one of i) the first Ethernet power based upon a number of missed switching pulses associated with regulating the first Ethernet power, and ii) the second Ethernet power based upon a number of missed switching pulses associated with regulating the second Ethernet power.

23. The method of claim 22, further comprising:
differentiating between a temporary loss of switching pulses and Ethernet power failure based upon a number of missed switching pulses.

24. The method of claim 20, wherein:
the second duty cycle is controlled; and
the second duty cycle is controlled such that the second duty cycle is maintained at a stand-off value less than that of the first duty cycle.

25. The method of claim 17, further comprising:
operating in one of three states;
wherein when operating in a first state, no duty cycle is controlled;
wherein when operating in a second state, the second duty cycle is controlled; and
wherein when operating in a third state, the first duty cycle is controlled.

26. The method of claim 25, further comprising:
transitioning from operating in the first state to operating in the second state when the measured first duty cycle is greater than the measured second duty cycle by more than a first threshold;
transitioning from operating in the first state to operating in the third state when the measured second duty cycle is greater than the measured first duty cycle by more than a second threshold; and
transitioning from operating in the second state to operating in the first state when the measured first duty cycle is less than the measured second duty cycle by less than a third threshold; and
transitioning from operating in the third state to operating in the first state when the measured second duty cycle is less than the measured first duty cycle by less than the third threshold.

27. The method of claim 26, wherein:
the first threshold and the second threshold are the same threshold; and
the third threshold is less than the first and the second thresholds.

28. The method of claim 27, wherein:
each of the first and the second thresholds are twenty percent; and
the third threshold is ten percent.

29. The method of claim 17, wherein the Ethernet device is configured in accordance with the IEEE 802.3af standard.
